(19) United States
(12) Patent Application Publication
(10) Pub. No.: US 2006/0233521 A1
(43) Pub. Date: Oct. 19, 2006

(54) Content playback method and content player

(75) Inventor: Naoko Takeda, Tokyo (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(73) Assignee: Sony Corporation, Tokyo (JP)

(21) Appl. No.: 11/368,707

(22) Filed: Mar. 7, 2006

(30) Foreign Application Priority Data
Mar. 8, 2005 (JP) 2005-063951

(51) Int. Cl. H04N 7/00

(52) U.S. Cl. 386/95

(57) ABSTRACT

A content playback method in a content player which searches for content data by a hierarchical structure defined based on a plurality of attributes, comprising a display step of displaying a plurality of classification items for classifying the content data on a screen, a classification item specification step of specifying a designated classification item in the hierarchical structure when playback of a predetermined classification item is designated in the plurality of classification items displayed on the screen, and a playback step of playing back content data allocated to a lower layer from the specified classification item and such a content player.

### CROSS REFERENCES TO RELATED APPLICATIONS

The present invention contains subject matter related to Japanese Patent Application No. 2005-063951 filed in the Japan Patent Office on Mar. 8, 2005, the entire contents of which being incorporated herein by reference.

### BACKGROUND OF THE INVENTION

1. Field of the Invention

The present invention relates to a content playback method and a content player.

2. Description of the Related Art

In recent years, the increasing larger capacity and smaller size of hard disk drives (HDD) and other storage media and the advances made in technology for compression of music, movies, still images, and other content data have made it possible to store an enormous amount of content data in the storage units of portable players, personal computers, and other electronic equipment. This type of electronic equipment is provided with-for example a shuffle function. When a shuffle mode is designated, it reads out and plays back content data stored in the storage medium at random (with a shuffle pattern). In conventional electronic equipment, however, when the shuffle mode is designated, shuffle playback is carried out covering all content data stored in the storage medium without considering the state of a search screen or the content data being played back. For more information on this related art, see Japanese Patent Publication (A) No. 2001-76415

In the electronic equipment explained above, the increasingly greater capacity of storage media means that there is a great possibility of a large amount of content data which the user is no longer interested in using being stored on a storage medium. In such case, when shuffle playback is carried out covering all content data recorded on a storage medium as in the above conventional electronic equipment, there is a great possibility of playback of a large amount of content data which the user is no longer interested in. The same problem occurs in a mode where the electronic equipment automatically selects and plays back content data without the user clearly designating specific content data.

### SUMMARY OF THE INVENTION

To overcome this inconvenience of the related art explained above, it is desirable to provide a content playback method and content player enabling automatic selection of content data for playback reflecting user instructions.

According to a first aspect of the invention, there is provided a content playback method in a content player which searches for content data by a hierarchical structure defined based on a plurality of attributes, comprising a display step of displaying a plurality of classification items for classifying the content data on a screen, a classification item specification step of specifying a designated classification item in the hierarchical structure when playback of a predetermined classification item is designated in the plurality of classification items displayed on the screen, and a playback step of playing back content data allocated to a lower layer from the specified classification item.

Preferably, the display step displays a plurality of classification items of attributes of the designated classification item when receiving a lower layer movement instruction of a predetermined classification item.

Alternatively, the playback step shuffles and plays back the content data allocated to the lower layer from the specified classification item.

More preferably, the playback step shuffles and plays back the content data allocated to the lower layer from the specified classification item.

Still more preferably, the playback step shuffles and plays back only content data allocated to classification items allocated to a lower layer from a specified classification item when the lower layer from the specified classification item is not a layer of content data.

Alternatively, the playback step shuffles and selects a plurality of classification items allocated to a lower layer from the specified classification item and plays back the content data of the selected classification items in a predetermined sequence.

Alternatively, the playback step selects a plurality of classification items allocated to a lower layer from the specified classification item in a predetermined sequence and shuffles and plays back the content data of the selected classification items.

Alternatively, the playback step shuffles and selects a plurality of classification items allocated to a lower layer from the designated classification item and shuffles and plays back the content data of the selected classification items.

Alternatively, the content player has a plurality of play modes, and the playback step shuffles and plays back only content data allocated to a lower layer from the specified classification item when judging that a first play mode is selected and shuffles and plays back all content data stored in the content player when judging that a second play mode is selected.

Alternatively, the display step displays as a highest layer at least two of genre, artist, album, track, track name search, and play list as the classification items.

According to a second aspect of the invention, there is provided a content player having a display for displaying data, a storage medium for storing content data, and a processing means for defining a hierarchical structure based on a plurality of attributes having the content data, displaying on the display a plurality of classification items for classifying the content data, specifying a designated classification item in the hierarchical structure when playback of a predetermined classification item among the plurality of classification items displayed on the display is designated, and playing back content data allocated to a lower layer from the specified classification item.

Preferably, the processing means causes display of a plurality of classification items of attributes of the designated classification item when receiving a lower layer movement instruction of a predetermined classification item.

Alternatively, the processing means shuffles and plays back the content data allocated to the lower layer from the specified classification item.

Alternatively, the processing means shuffles and plays back only the content data allocated to the lower layer from the specified classification item.

More preferably, the processing means shuffles and plays back only content data allocated to classification items allocated to a lower layer from a specified classification item when the lower layer from the specified classification item is not a layer of content data.

Alternatively, the processing means shuffles and sequentially selects a plurality of classification items allocated to a lower layer from the specified classification item and plays back the content data of the selected classification items in a predetermined sequence.

Alternatively, the processing means selects a plurality of classification items allocated to a lower layer from the specified classification item in a predetermined sequence and shuffles and plays back the content data of the selected classification items.

Alternatively, the processing means shuffles and sequentially selects a plurality of classification items allocated to a lower layer from the designated classification item and shuffles and plays back the content data of the selected classification items.

Alternatively, the content player has a plurality of play modes, and the processing means shuffles and plays back only content data allocated to a lower layer from the specified classification item when judging that a first play mode is selected and shuffles and plays back all content data stored in the content player when judging that a second play mode is selected.

According to a third aspect of the invention, there is provided a content player for displaying a search screen wherein a plurality of classification items for classifying content data are defined for each of a plurality of attributes of the content data and searching for content data based on the attributes and the classification items, comprising a storage medium for storing a plurality of content data; a display; an operating means; and a processing means for defining the attributes and the classification items in a hierarchical structure, displaying the search screen for designating any classification item from among the plurality of classification items defined in the attributes linked with the layer in each layer on the display, specifying the designated classification item in the hierarchical structure when receiving a playback instruction in a state where a classification item on the displayed search screen is designated by a designation operation by the operating means, reading out the content data assigned to a lower layer of the specified classification item from the storage medium, and playing back the same.

### BRIEF DESCRIPTION OF THE DRAWINGS

These and other objects and features of the present invention will become clearer from the following description of the preferred embodiments given with reference to the attached drawings, wherein:

FIG. 1 is a view of the configuration of a content player according to an embodiment of the present invention;

FIGS. 2A to 2C are views for explaining an outer appearance of the content player shown in FIG. 1;

FIG. 3 is a view for explaining a screen change of an LCD panel shown in FIG. 1;

FIG. 4 is a view for explaining various types of screens displayed on the LCD panel in FIG. 1;

FIG. 5 is a view for explaining a hierarchical structure of a track selection screen displayed on the LCD panel shown in FIG. 1;

FIG. 6 is a view for explaining a change of the track selection screen displayed on the LCD panel shown in FIG. 1;

FIG. 7 is a view for explaining a change of the track selection screen displayed on the LCD panel shown in FIG. 1;

FIG. 8 is a view for explaining a pattern of playback of the content player shown in FIG. 1;

FIG. 9 is a flow chart for explaining an example of operation of a CPU where a cross execute key is depressed during display of the track selection screen on the LCD panel shown in FIG. 1;

FIG. 10 is a view for explaining an example of operation of step ST14 shown in FIG. 9; and

FIG. 11 is a view for explaining an example of operation of step ST15 shown in FIG. 9.

### DESCRIPTION OF THE PREFERRED EMBODIMENTS

Below, an embodiment of the present invention will be explained.

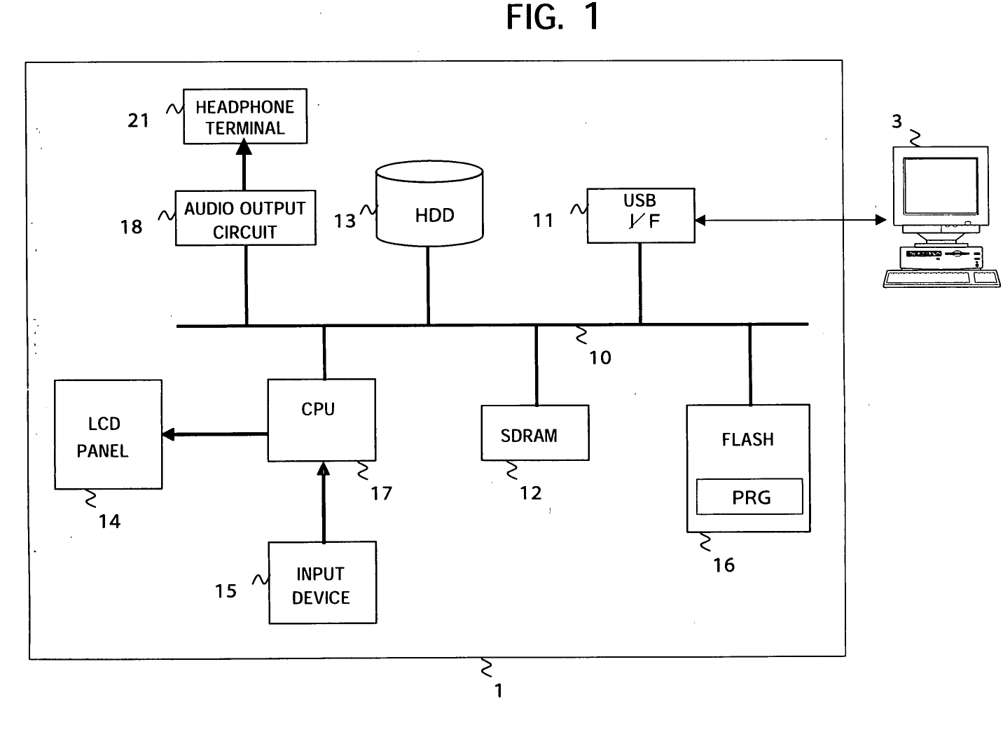

Below, a content player according to an embodiment of the present invention will be explained. FIG. 1 is a view of the configuration of a content player 1 according to an embodiment of the present invention. The content player 1 is for example a portable audio player. As shown in FIG. 1, the content player 1 has for example a universal serial bus (USB) interface 11, a synchronous dynamic random access memory (SDRAM) 12, a hard disk drive (HDD) 13, a liquid crystal display (LCD) panel 14, an input device 15, a flash memory 16, a central processing unit (CPU) 17, and an audio output circuit 18. The USB interface 11, SDRAM 12, HDD 13, flash memory 16, CPU 17, and audio output circuit 18 are connected via for example a data line 10.

The USB interface 11 is connected to a personal computer 3 and enables data input/output with a personal computer 3. The SDRAM 12 temporarily stores the data etc. related with the processing of the CPU 17.

The HDD 13 stores the compressed music data. The music data is written into the HDD 13 from the personal computer 3 via the USB interface 11. The HDD 13 has a storage capacity of for example 20 GB and can store about 10,000 tracks (700 compact discs) worth of music data compressed by adaptive transform acoustic coding (ATRAC) 3 etc. The attributes such as the genre, artist, album, track name, and play list (attribute data) are attached to each track's worth of the music data stored in the HDD 13 (hereinafter, also simply referred to as music data). The genre attribute indicates the genre to which the music of the music data belongs. The artist attribute indicates the artist who for example plays the music of the music data. The album attribute indicates the album to which the music data belongs. The track name attribute indicates the track name of the music data. The play list indicates the group of the music data determined by the user.

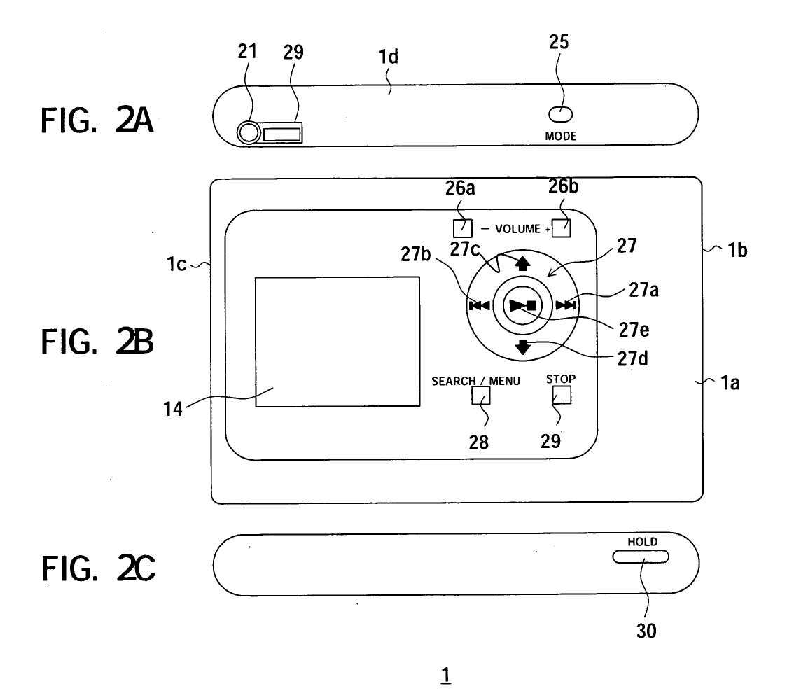

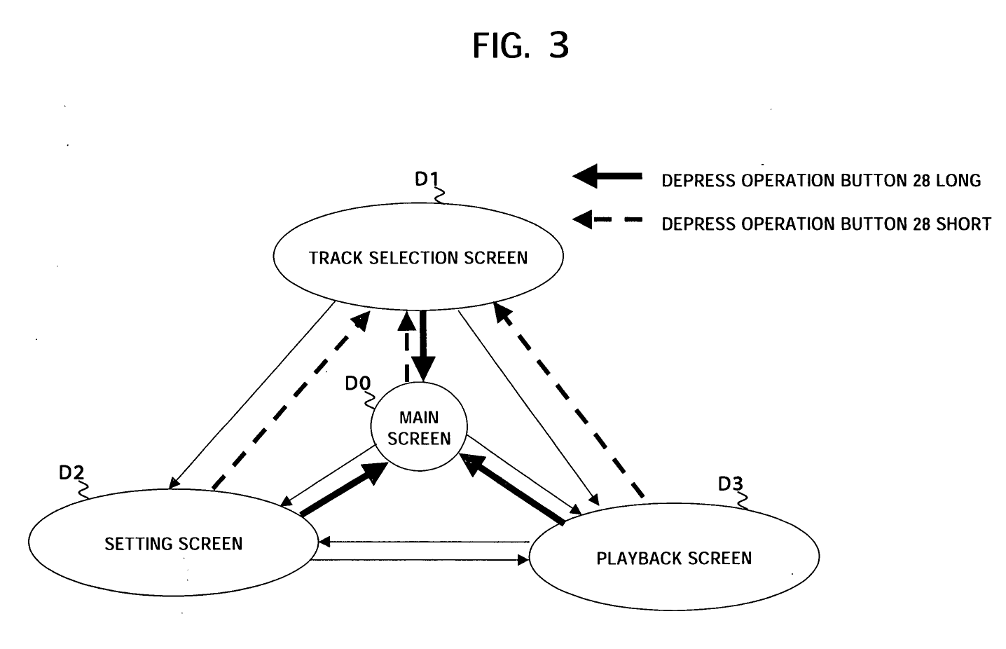

The LCD panel 14 is provided at the front of the housing of the content player 1 as shown in FIGS. 2A TO 2CB. The LCD panel 14 displays various screens by the CPU 17. The main screens displayed on the LCD panel 14 include, for example, as shown in FIG. 3, a main screen D0, a track selection screen D1, a setting screen D2, and a playback screen D3. These screens are switched (shifted) in response to a key operation of the user.

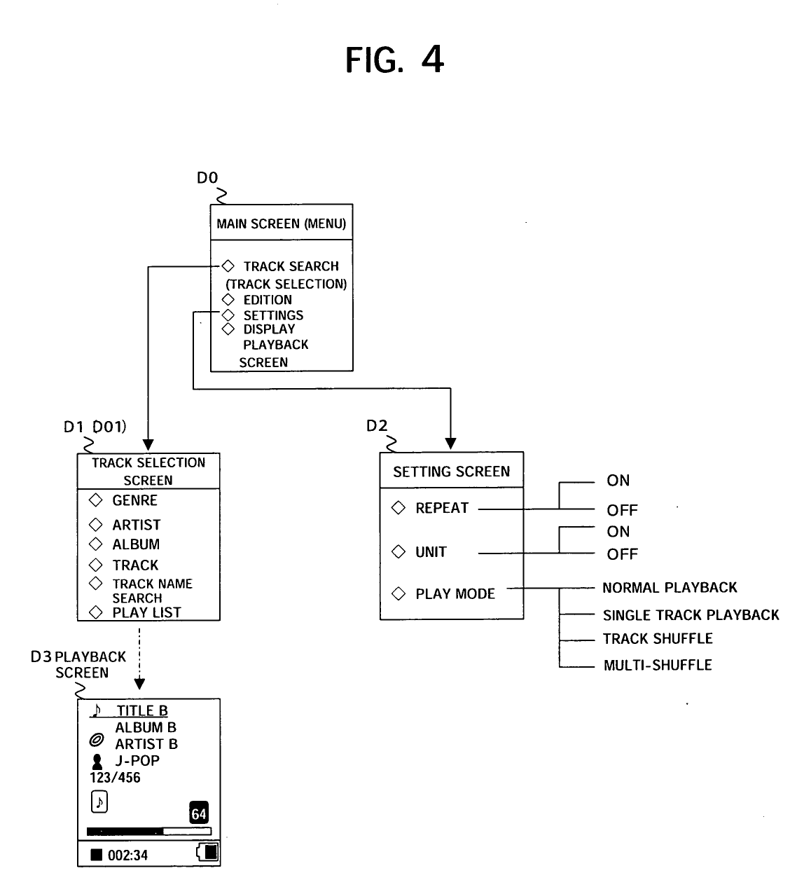

The main screen DO displays, for example, as shown in FIG. 4, “track search (track selection)”, “editing”, “setting”, “playback screen display”, and other items. A screen linked with a selected item is displayed by the user selecting that item. The track selection screen D1 is displayed in for example a case where the item “track search” is selected on the main screen D0 and is the track selection screen of the highest layer. The track selection screen D1 displays, for example, as shown in FIG. 4, classification items such as “genre”, “artist”, “album”, “track”, “track name search”, and “play list”. The processing when a classification item is selected will be explained in detail later.

The setting screen D2 is displayed when the item of “setting” is selected in the main screen D0. The setting screen D2 displays items of “repeat”, “unit”, and “play mode”. The item “repeat” is used for turning the repeat playback function ON or OFF in response to the operation of the user. The item “unit” is used for turning the unit playback function ON or OFF in response to the operation of the user. The “play mode” is used for setting normal play, single track play, track shuffle, and multi-shuffle in response to the operation of the user.

The playback screen D3 is the screen displayed during playback of the music data selected by the user based on the track selection screen D1. As shown in FIG. 4, it displays information such as the title, album, artist, and genre of the music data being played back.

The input device 15 shown in FIG. 1 comprises keys provided on the housing of the content player 1 and operated by the user. The input device 15, for example, as shown in FIGS. 2A TO 2CA, FIGS. 2A TO 2CB, and FIGS. 2A TO 2CC, includes a remote control terminal 29, a MODE key 25, VOLUME keys 26a and 26b, a cross key 27, a SEARCH/MENU key 28, a STOP key 29, and a HOLD key 30.

The MODE key 25 is used for selecting for example one mode from among a plurality of modes in each of the repeat, unit, and play modes on the setting screen D2 shown in FIG. 4. The VOLUME keys 26a and 26b are used for turning the volume up and down. The cross key 27 includes a cross right key 27a, a cross left key 27b, a cross top key 27c, a cross bottom key 27d, and a cross execute key 27e. The cross right key 27a and the cross let key 27b are used when switching for example the layer of the track selection screen D1 as will be explained later. Further, they are also used for a head search and fast forwarding/rewinding of the track. The cross top key 27c and the cross bottom key 27d are used for moving the cursor in the up/down direction on the track selection screen D1 and the setting screen D2. The cross execute key 27e is used for selecting (executing) the item where the cursor is located and inputting a playback instruction. The SEARCH/MENU key 28 is used, for example, for inputting an instruction for displaying the track selection screen D1 of the first layer by a short depression and is used for inputting an instruction for displaying the menu screen by a long depression.

The flash memory 16 stores for example a program PRG defining the operation of the CPU 17. The CPU 17 centrally controls the operation of the content player 1, that is, performs the processing explained in the present embodiment based on the program PRG read out from the flash memory 16. The CPU 17 performs the processing for displaying the main screen D0, track selection screen D1, setting screen D2, and playback screen D3 shown in FIG. 4 on the LCD panel 14. Further, the CPU 17 performs processing for reading the selected music data from the HDD 13 and decoding and playing it back.

The audio output circuit 18 outputs an audio signal in accordance with the music data decoded by the CPU 17 to a headphone terminal 21.

Below, the track selection screen D1 shown in FIG. 4 will be explained. The track selection screen D1 includes a plurality of track selection screens D01 of the first layer defined for the plurality of different attributes (attributes concerning the music data) and displaying the plurality of classification items defined for the attributes to prompt the user to select the same. Further, the track selection screen D1 includes track selection screens of the-second and following layers for the track selection screens of the first layer described above. The track selection screens of the second and following layers are defined for the classification items of the track selection screens of the upper layers. Each has a plurality of classification items for classifying the music data belonging to the classification items based on the attributes other than the above attributes corresponding to the classification items.

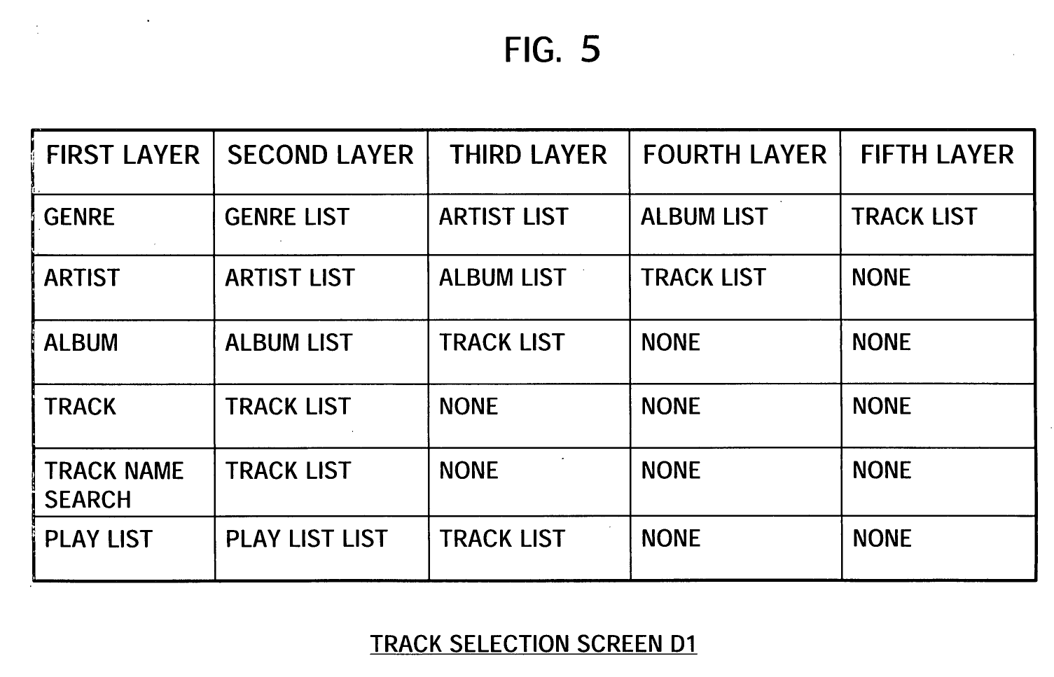

FIG. 5 is a view for explaining the hierarchical structure of the track selection screen D1. As shown in FIG. 5, as the first layer, classification items (“genre”, “artist”, “album”, “track”, “track name search”, “play list”) of the track selection screen D1 shown in FIG. 4 are defined. Further, a genre list is defined as a second layer below the “genre” of the first layer, an artist list is defined as a third layer below this, an album list is defined as a fourth layer below this, and a track list is defined as a fifth layer below this.

Further, an artist list is defined as a second layer below the “artist” of the first layer, an album list is defined as a third layer below this, and a track list is defined as a fourth layer below this. An album list is defined as a second layer below the “album” of the first layer, and a track list is defined as a third layer below this. Track lists are defined as second layers below the “track” and “track name search” of the first layer. A list of play lists is defined as a second layer below the “play list” of the first layer, and a track list is defined as a third layer below this.

In the hierarchical structure shown in FIG. 5, as explained above, different attributes are assigned to different layers. At each layer, a plurality of classification items classifying the music data based on the attributes assigned to the layers are defined. The plurality of classification items defined in each layer receive the attributes of the corresponding classification items in the higher layers of the hierarchy. The content is managed based on the above hierarchical structure in a player.

The CPU 17 changes in state according to the hierarchical structure shown in FIG. 5 in accordance with an operation of the user using the MODE key 25, cross key 27, and SEARCH/MENU key 28 and displays the track selection screen of the layer linked with the state after the change of the LCD panel 14.

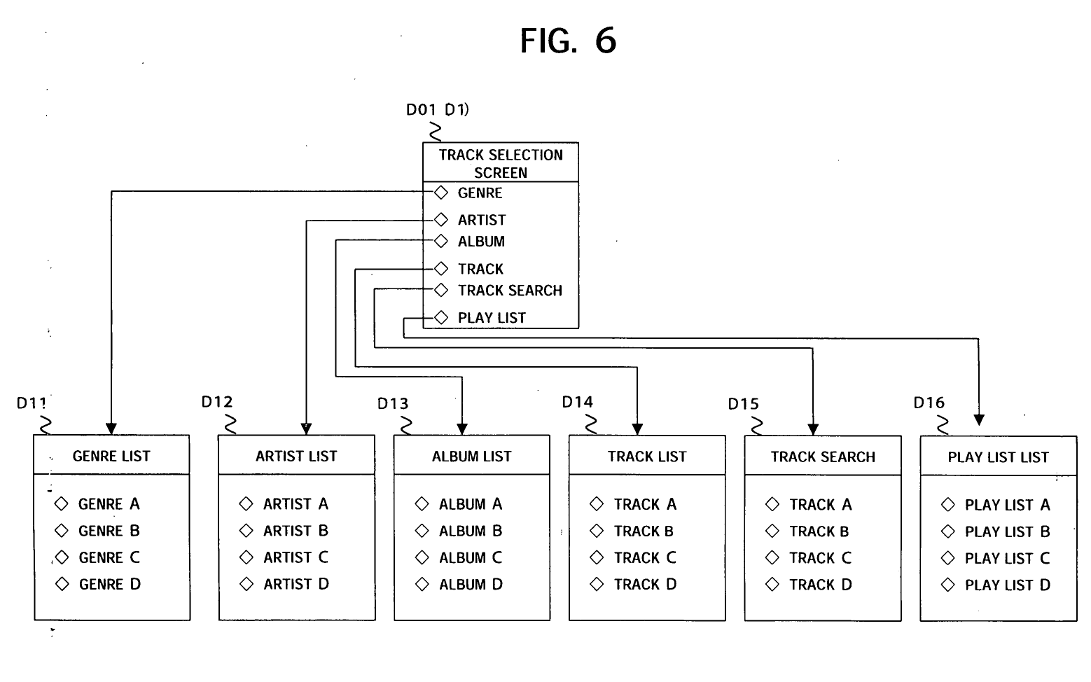

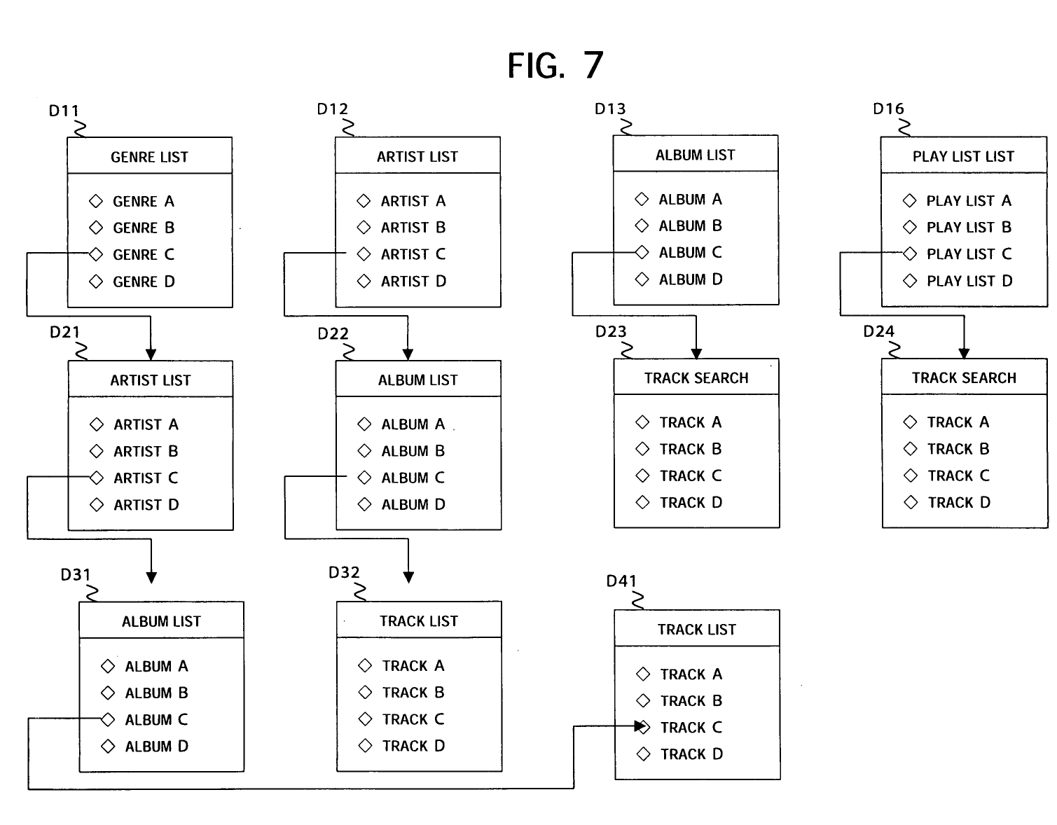

FIG. 6 and FIG. 7 are views for explaining the track selection screen D1 of each layer shown in FIG. 5. First, when the user depresses the SEARCH/MENU key 28 shown in FIGS. 2A to 2C for a short time, the CPU 17 displays the track selection screen D01 (D1) of the first layer shown in FIG. 6 on the LCD panel 14.

In the present embodiment, the change of the track selection screen shown in FIG. 6, FIG. 7, etc. is accomplished by moving the cursor in the track selection screen by for example the user operating the cross key 27 shown in FIGS. 2A TO 2C. When “genre” is selected on the track selection screen D01 shown in FIG. 6, the CPU 17 displays the track selection screen D11 showing the genre list on the LCD panel 14. On the track selection screen D11, a previously determined plurality of genres A, B, C, and D is displayed as classification items. As shown in FIG. 7, on the track selection screen D11, when the classification item of “genre C” (for example a genre of artists) is selected, the CPU 17 displays a track selection screen D21 indicating a list of artists belonging to the selected genre on the LCD panel 14. As shown in FIG. 7, when the classification item of “artist C” (for example an artist of albums) is selected on the track selection screen D21, the CPU 17 displays a track selection screen D31 showing a list of albums belonging to the selected artist on the LCD panel 14. As shown in FIG. 7, when the classification item of “album C” (for example, an album of tracks) is selected on the track selection screen D31, the CPU 17 displays a track selection screen D41 showing a list of music names (track names) belonging to the selected album on the LCD panel 14.

When the classification item of “artist” is selected on the track selection screen D01 shown in FIG. 6, the CPU 17 displays a track selection screen D12 showing an artist list on the LCD panel 14. On the track selection screen D12, artist names A, B, C, and D of all music data stored in the HDD 13 are displayed as classification items. As shown in FIG. 7, when the classification item of “artist C” is selected on the track selection screen D12, the CPU 17 displays a track selection screen D22 showing a list of albums belonging to the selected artist on the LCD panel 14. As shown in FIG. 7, when the classification item of “album C” is selected on the track selection screen D22, the CPU 17 displays a track selection screen D32 showing a list of music names (track names) belonging to the selected album on the LCD panel 14.

When “album” is selected on the track selection screen D01 shown in FIG. 6, the CPU 17 displays a track selection screen D13 showing an album list on the LCD panel 14. On the track selection screen D13, album names A, B, C, and D of all music data stored in the HDD 13 are displayed as classification items. As shown in FIG. 7, when the classification item of “album C” is selected on the track selection screen D13, the CPU 17 displays a track selection screen D23 showing a list of music names (track names) belonging to the selected album on the LCD panel 14.

When “play list” is selected on the track selection screen D01 shown in FIG. 6, the CPU 17 displays a track selection screen D16 showing a list of play lists on the LCD panel 14. On the track selection screen D16, play lists A, B, C, and D designated by the user are displayed as classification items. When the item of “play list C” is selected on the track selection screen D16 shown in FIG. 6, the CPU 17 displays a track selection screen D24 showing a list of music names (track names) belonging to the selected play list on the LCD panel 14.

When tracks are selected on the track selection screens D41, D32, D23, and D24 showing track lists, the CPU 17 reads the music data of the selected tracks from the HDD 13, performs the playback processing, and outputs the same to the audio output circuit 18.

Below, the unit, repeat, and play modes set (selected) by the setting screen D2 shown in FIG. 4 will be explained. When the cross execute key 27e shown in FIG. 2B is depressed during display of for example the track selection screen D1 of each layer explained by using FIG. 5 to FIG. 7 on the LCD panel 14, the CPU 17 selects the items of the lower layer from the item where the cursor is located on the track selection screen D1 being displayed as the unit. In the present embodiment, the user sets whether or not to play back the unit using the items of the unit on the setting screen D2 shown in FIG. 4.

When the cross execute key 27e is depressed in the state with the repeat ON and unit ON (when receiving the playback instruction), the CPU 17 repeats processing for sequentially selecting and playing back the items in the unit by a pattern in accordance with the play mode (performs repeat playback). When the cross execute key 27e is depressed in the state with the repeat ON and unit OFF, the CPU 17 repeats processing for playing back the previously determined music data or music data group (performs repeat playback). When the cross execute key 27e is depressed in the state with the repeat OFF and unit ON, the CPU 17 performs processing for sequentially selecting and playing back the items in the unit by a pattern in accordance with the play mode only one time. When the cross execute key 27e is depressed in the state with the repeat OFF and unit OFF, the CPU 17 performs processing for playing back the previously determined music data or music data group only one time.

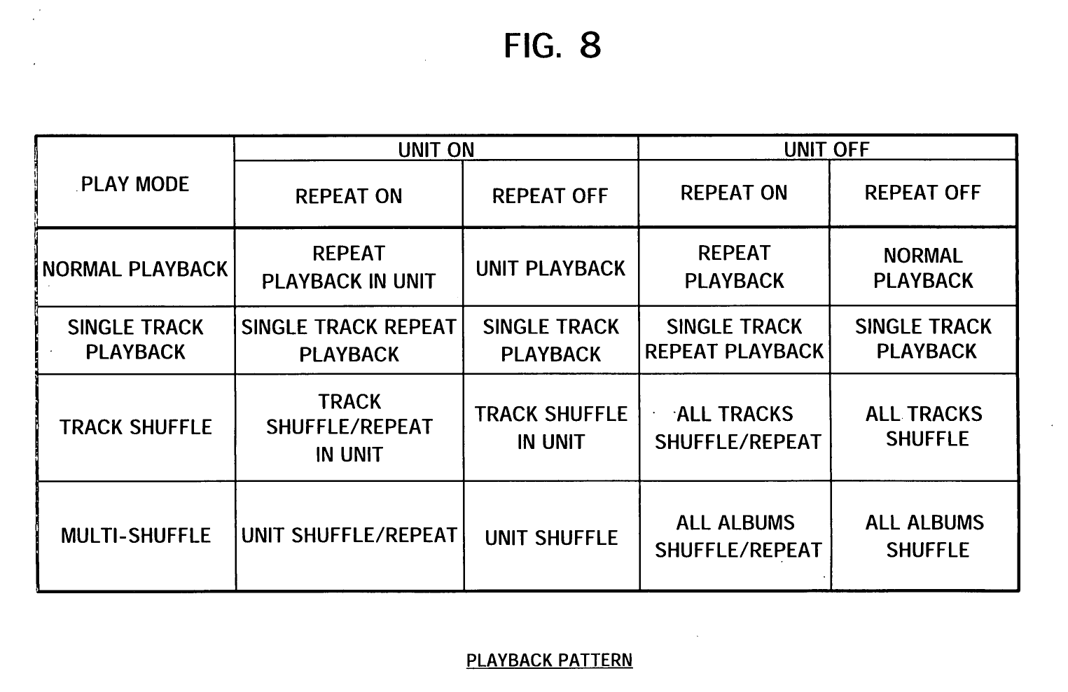

FIG. 8 is a view for explaining the playback processing in combinations of the play mode, unit ON/OFF, and repeat ON/OFF. In the present embodiment, the play mode includes normal playback, single track playback, track shuffle, and multi-shuffle. The user sets this by using the item of “play mode” on the setting screen D2 shown in FIG. 4.

Below, an example of operation of the content player 1 of the present embodiment related to the processing of the CPU 17 shown in FIG. 1 will be explained.

Example of Playback Operation

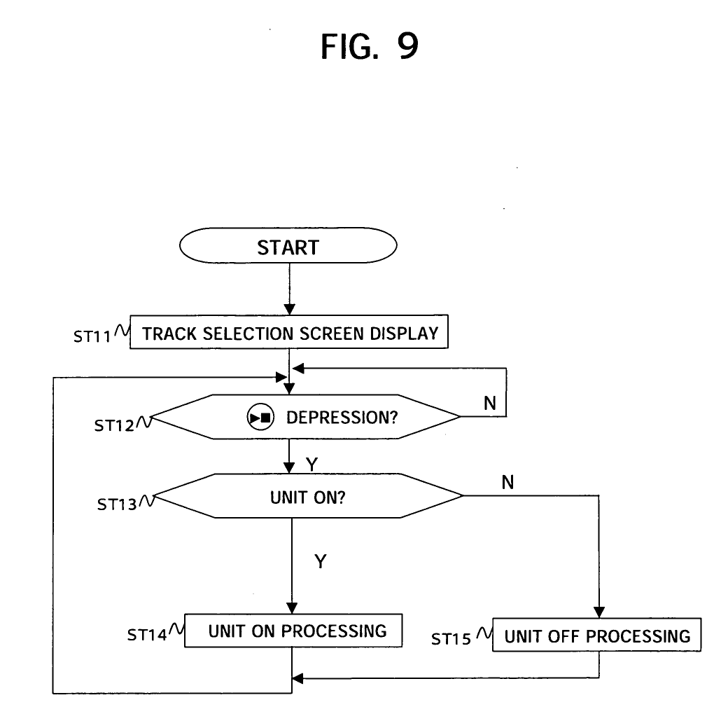

In the present example of operation, the example of operation of the CPU 17 when the cross execute key 27e is depressed during the display of the track selection screen D1 will be explained. FIG. 9 is a view for explaining the example of operation. Below, the steps shown in FIG. 9 will be explained.

Step ST11

When detecting for example the short depression of the SEARCH/MENU key 28 shown in FIG. 2B, the CPU 17 displays the track selection screen D01 of the highest layer shown in FIG. 6 and then displays the track selection screen of each layer on the LCD panel 14 in accordance with the operation of the cross key 27 by the user.

Step ST12

When detecting that the cross execute key 27e is depressed during the display of a track selection screen, the CPU 17 proceeds to step ST13.

Step ST13

The CPU 17 judges if “unit” is set ON, proceeds to step ST14 when judging that “unit” is set ON, and proceeds to step ST15 when not judging so.

Step ST14

As will be explained later, when the cross execute key 27e is depressed at step ST12, the CPU 17 selects the classification items of the lower layer from the classification item where the cursor is located on the track selection screen D1 being displayed as the unit, reads out the music data from the HDD 13, and performs the playback processing based on that unit.

Step ST15

The CPU 17 reads out the music data from the HDD 13 to perform the playback processing based on the previously determined pattern as will be explained later.

Example of Playback Operation in Case of “Unit” ON

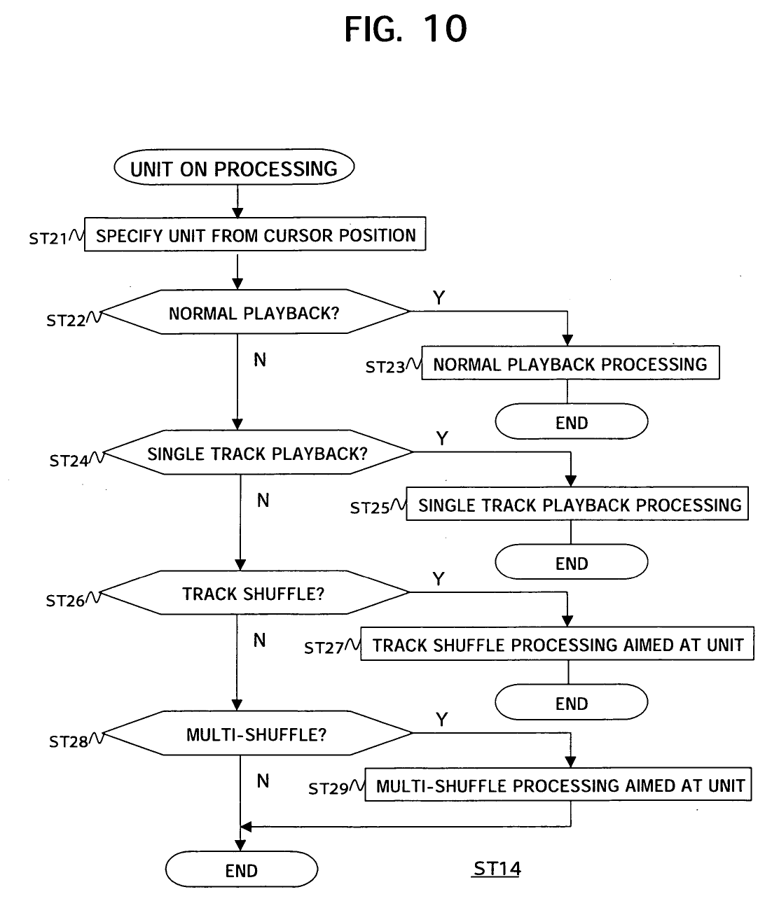

FIG. 10 is a view for explaining an example of the operation of step ST14 shown in FIG. 9. Below, an explanation will be given of the steps shown in FIG. 10.

Step ST21

Where the cross execute key 27e shown in FIGS. 2A TO 2C is depressed during display of the track selection screen D1 of each layer explained by using FIG. 5 to FIG. 7 on the LCD panel 14, the CPU 17 selects the items of the lower layer from the classification item where the cursor is located on the track selection screen D1 as the unit. For example, when the cross execute key 27e is depressed during the display of the track selection screen D11 shown in FIG. 7, the CPU 17 specifies (selects) the artists A, B, C, and D of the lower layer from the genre C where the cursor is located on the track selection screen D11 as the unit.

Step ST22

The CPU 17 judges whether or not normal playback is selected as the play mode, proceeds to step ST23 when judging that normal playback is selected, and proceeds to step ST24 when not judging so.

Step ST23

The CPU 17 selects the music data of the unit specified at step ST21 in the previously determined sequence and plays back the same in the selection sequence. Further, when the lower layer of the selected unit described above is not music data, the CPU 17 sequentially selects the classification items in the lower layer and sequentially selects and plays back the music data in the selected unit. The CPU 17 repeats the playback processing when “repeat” is ON and performs the series of playback processing only one time when “repeat” is OFF.

Step ST24

The CPU 17 judges whether or not single track playback is selected as the play mode, proceeds to step ST25 when judging that single track playback is selected, and proceeds to step ST26 when not judging so.

Step ST25

The CPU 17 selects the classification item at the head of the unit specified at step ST21 and, when the classification item at the head is music data, plays it back. Further, when the lower layer of the selected unit is not music data, the CPU 17 selects and plays back the music data at the head of the further lower layer from the classification item at the head of that lower layer. The CPU 17 repeats the playback processing of the track when “repeat” is ON, while performs the playback processing of the track only one time when “repeat” is OFF.

Step ST26

The CPU 17 judges whether or not track shuffle is selected as the play mode, proceeds to step ST27 when judging that the track shuffle is selected, and proceeds to step ST28 when not judging so.

Step ST27

The CPU 17 selects the classification items (classification items which are not music data) in the unit specified at step ST21 in a predetermined sequence and sequentially selects and plays back the music data in the selected classification items with a shuffle pattern. When the classification items in the unit specified at step ST21 are music data, the CPU 17 sequentially selects and plays back the music data with a shuffle pattern. The CPU 17 repeats the above playback processing when “repeat” is ON, while performs the above series of playback processing only one time when “repeat” is OFF.

Step ST28

The CPU 17 judges whether or not multi-shuffle is selected as the play mode, proceeds to step ST29 when judging that multi-shuffle is selected, and ends the processing when not judging so.

Step ST29

The CPU 17 selects the classification items (classification items which are not music data) in the unit specified at step ST21 with a shuffle pattern and sequentially selects and plays back the music data in the selected classification items in a predetermined sequence. When the classification items in the unit specified at step ST21 are music data, the CPU 17 sequentially selects and plays back the music data with a shuffle pattern. The CPU 17 repeats the above playback processing when “repeat” is ON, while performs the above series of playback processing only one time when “repeat” is OFF.

Example of Playback Operation in Case of “Unit” OFF

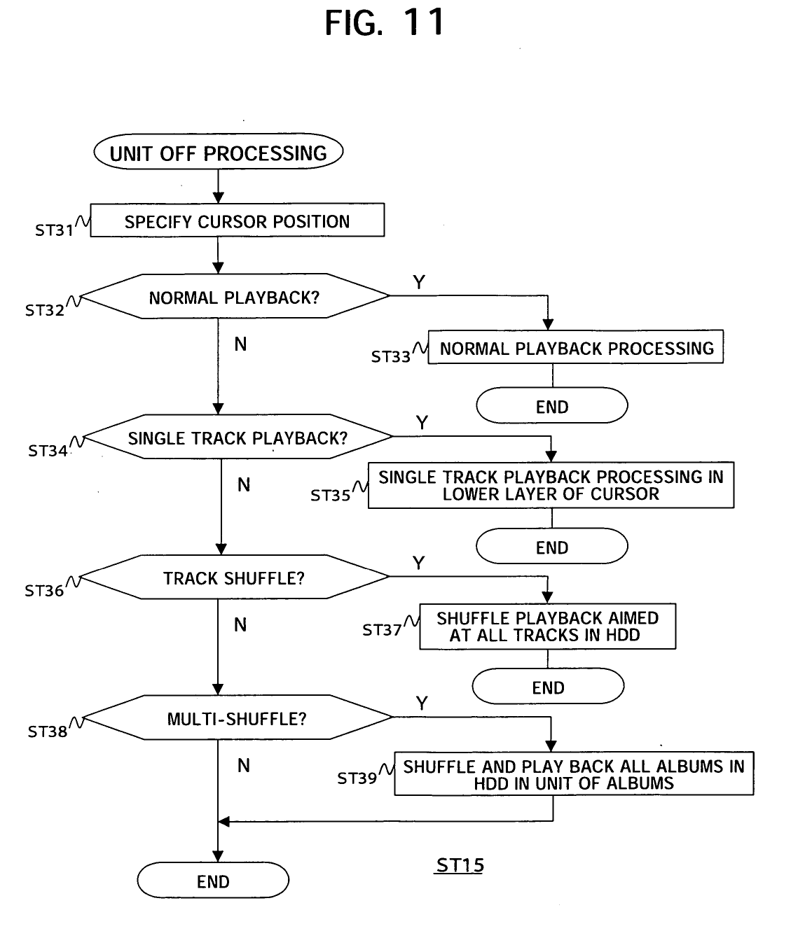

FIG. 11 is a view for explaining an example of operation of step ST15 shown in FIG. 9. Below, an explanation will be given on the steps shown in FIG. 11.

Step ST31

For example, when the cross execute key 27e shown in FIGS. 2A TO 2C is depressed during the display of the track selection screen D1 of each layer explained by using FIG. 5 to FIG. 7 on the LCD panel 14, the CPU 17 specifies the position of the cursor on the track selection screen D1 being displayed.

Step ST32

The CPU 17 judges whether or not normal playback is selected as the play mode, proceeds to step ST33 when judging that normal playback is selected, and proceeds to step ST34 when not judging so.

Step ST33

The CPU 17 sequentially selects and plays back the music data of the lower layer from the classification item of the cursor position specified at step ST31. The CPU 17 repeats the above playback processing when “repeat” is ON, while performs the above series of playback processing only one time when “repeat” is OFF.

Step ST34

The CPU 17 judges whether or not single track playback is selected as the play mode, proceeds to step ST35 when judging that single track playback is selected, and proceeds to step ST36 when not judging so.

Step ST35

The CPU 17 plays back the music data of the track at the head of the music data at the lower layer from the cursor position specified at step ST31. The CPU 17 repeats the playback processing of that track when “repeat” is ON, while performs the playback processing of that track only one time when “repeat” is OFF.

Step ST36

The CPU 17 judges whether or not track shuffle is selected as the play mode, proceeds to step ST37 when judging that track shuffle is selected, and proceeds to step ST38 when not judging so.

Step ST37

The CPU 17 sequentially selects and plays back all music data stored in the HDD 13 with the shuffle pattern. The CPU 17 repeats the above playback processing when “repeat” is ON, while performs the above series of playback processing only one time when “repeat” is OFF.

Step ST38

The CPU 17 judges whether or not multi-shuffle is selected as the play mode, proceeds to step ST38 when judging that multi-shuffle is selected, and ends the processing when not judging so.

Step ST39

The CPU 17 shuffles and plays back all music data stored in the HDD 13 in unit of albums. The CPU 17 repeats the above playback processing when “repeat” is ON, while performs the above series of playback processing only one time when “repeat” is OFF.

As explained above, according to the content player 1, as explained by using steps ST26 and ST27 shown in FIG. 10, when the cross execute key 27e is depressed, the music data in the lower layer from the classification item where the cursor is located on the track selection screen D1 is selected for playback. Here, the user usually positions the cursor at the classification item interested in on the track selection screen D1. For this reason, according to the content player 1, by selecting the music data in the lower layer from the classification item where the cursor is located on the track selection screen D1 for playback, the user can automatically select and play back music data interested in to a certain extent in any play mode.

Further, according to the content player 1, as shown in FIG. 10 and FIG. 11 etc., by the designation of the play mode and turning “unit” ON/OFF, a variety of modes of shuffle playback are carried out. Due to this, it becomes possible to shuffle and play back music in accordance with the preferences of the user.

Further, according to the content player 1, as explained above, the SEARCH/MENU key 28 is used for inputting an instruction for displaying the track selection screen D1 in the first layer by short depression and is used for inputting an instruction for displaying the menu screen by long depression. Due to this, it becomes possible to perform a variety of operations with a small number of operation keys without degrading the operation property.

The present invention is not limited to the above embodiment. In the above embodiment, as the shuffle playback, track shuffle and multi-shuffle were exemplified, but other than this, it is also possible to select the above determined unit with a shuffle pattern and further select and play back the music data in the unit with a shuffle pattern.

In the above embodiment, the SEARCH/MENU key 28 was used for inputting an instruction for displaying the track selection screen D1 of the first layer by short depression and was used for inputting an instruction for displaying the menu screen by long depression, but it is also possible to switch the function of the SEARCH/MENU key 28 by a method other than this, for example, in accordance with the operation state of the content player 1.

Further, in the above embodiment, the case where the present invention was applied to a portable type audio player was exemplified, but the present invention can also be applied to devices other than a portable type such as a personal computer. Further, in the above embodiment, as the content data of the present invention, audio data such as music data was exemplified, but image data such as videos and photos may also be used too.

Further, in the present invention, as the storage means for storing the content data, in place of the HDD 13 shown in FIG. 1, an opto-magnetic storage medium such as an MD®, an optical storage medium such as a CD-R (CD-recordable) and a DVD-R (DVD-recordable), and a semiconductor memory such as a Memory Stick® and SD card® may be used.

Further, in the above embodiment, a portable type audio player was exemplified as the content player 1, but the content player 1 may also be for example a personal computer, a compact disk or other optical disc player, or an opto-magnetic disc player.

Further, the screen displayed on the LCD panel 14 explained in the present embodiment may also be displayed on for example the display of a remote controller connected to the headphone line.

The present invention can be applied to electronic equipment for displaying search screens of content data.

It should be understood by those skilled in the art that various modifications, combinations, sub-combinations and alterations may occur depending on design requirements and other factors insofar as they are within the scope of the appended claims or the equivalents thereof.

1. A content playback method in a content player which searches for content data by a hierarchical structure defined based on a plurality of attributes, comprising
a display step of displaying a plurality of classification items for classifying the content data on a screen,
a classification item specification step of specifying a designated classification item in said hierarchical structure when playback of a predetermined classification item is designated in the plurality of classification items displayed on said screen, and
a playback step of playing back content data allocated to a lower layer from the specified classification item.

2. A content playback method as set forth in claim 1, wherein said display step displays a plurality of classification items of attributes of said designated classification item when receiving a lower layer movement instruction of a predetermined classification item.

3. A content playback method as set forth in claim 1, wherein said playback step shuffles and plays back the content data allocated to the lower layer from the specified classification item.

4. A content playback method as set forth in claim 3, wherein said playback step shuffles and plays back the content data allocated to the lower layer from the specified classification item.

5. A content playback method as set forth in claim 4, wherein said playback step shuffles and plays back only content data allocated to classification items allocated to a lower layer from a specified classification item when the lower layer from the specified classification item is not a layer of content data.

6. A content playback method as set forth in claim 1, wherein said playback step shuffles and selects a plurality of classification items allocated to a lower layer from said specified classification item and plays back the content data of the selected classification items in a predetermined sequence.

7. A content playback method as set forth in claim 1, wherein said playback step selects a plurality of classification items allocated to a lower layer from said specified classification item in a predetermined sequence and shuffles and plays back the content data of the selected classification items.

8. A content playback method as set forth in claim 1, wherein said playback step shuffles and selects a plurality of classification items allocated to a lower layer from said designated classification item and shuffles and plays back the content data of the selected classification items.

9. A content playback method as set forth in claim 1, wherein
said content player has a plurality of play modes, and
said playback step shuffles and plays back only content data allocated to a lower layer from said specified classification item when judging that a first play mode is selected and shuffles and plays back all content data stored in said content player when judging that a second play mode is selected.

10. A content playback method as set forth in claim 1, wherein said display step displays as a highest layer at least two of genre, artist, album, track, track name search, and play list as said classification items.

11. A content player comprising:
a display for displaying data,
a storage medium for storing content data, and
a processing means for defining a hierarchical structure based on a plurality of attributes having said content data, displaying on said display a plurality of classification items for classifying said content data, specifying a designated classification item in said hierarchical structure when playback of a predetermined classification item among the plurality of classification items displayed on the display is designated, and playing back content data allocated to a lower layer from said specified classification item.

12. A content player as set forth in claim 11, wherein said processing means causes display of a plurality of classification items of attributes of said designated classification item when receiving a lower layer movement instruction of a predetermined classification item.

13. A content player as set forth in claim 11, wherein said processing means shuffles and plays back the content data allocated to the lower layer from the specified classification item.

14. A content player as set forth in claim 13, wherein said processing means shuffles and plays back only the content data allocated to the lower layer from the specified classification item.

15. A content player as set forth in claim 14, wherein said processing means shuffles and plays back only content data allocated to classification items allocated to a lower layer from a specified classification item when the lower layer from the specified classification item is not a layer of content data.

16. A content player as set forth in claim 11, wherein said processing means shuffles and sequentially selects a plurality of classification items allocated to a lower layer from said specified classification item and plays back the content data of the selected classification items in a predetermined sequence.

17. A content player as set forth in claim 11, wherein said processing means selects a plurality of classification items allocated to a lower layer from said specified classification item in a predetermined sequence and shuffles and plays back the content data of the selected classification items.

18. A content player as set forth in claim 11, wherein said processing means shuffles and sequentially selects a plurality of classification items allocated to a lower layer from said designated classification item and shuffles and plays back the content data of the selected classification items.

19. A content player as set forth in claim 11, wherein
said content player has a plurality of play modes, and
said processing means shuffles and plays back only content data allocated to a lower layer from said specified classification item when judging that a first play mode is selected and shuffles and plays back all content data stored in said content player when judging that a second play mode is selected.

20. A content player for displaying a search screen wherein a plurality of classification items for classifying content data are defined for each of a plurality of attributes of the content data and searching for content data based on the attributes and the classification items, comprising:
a storage medium for storing a plurality of content data;
a display;
an operating means; and
a processing means for defining the attributes and the classification items in a hierarchical structure, displaying the search screen for designating any classification item from among the plurality of classification items defined in the attributes linked with the layer in each layer on the display, specifying the designated classification item in the hierarchical structure when receiving a playback instruction in a state where a classification item on the displayed search screen is designated by a designation operation by the operating means, reading out the content data assigned to a lower layer of the specified classification item from the storage medium, and playing back the same.
